(19) United States
(12) Patent Application Publication
(10) Pub. No.: US 2025/0047781 A1
(43) Pub. Date: Feb. 6, 2025

(54) Multimodal phone call application for users with language barriers and/or hearing impairment

(71) Applicants: Ryan Zargham Cheng, Studio City, CA (US); Kian Nathan Sharifi, Pacific Palisades, CA (US)

(72) Inventors: Ryan Zargham Cheng, Studio City, CA (US); Kian Nathan Sharifi, Pacific Palisades, CA (US)

(21) Appl. No.: 18/365,215

(22) Filed: Aug. 4, 2023

(51) Int. Cl. H04M 3/42; G06F 40/58; G10L 13/02; G10L 15/26; H04M 3/493

(52) U.S. Cl. CPC H04M 3/42382; G06F 40/58; G10L 13/02; G10L 15/26; H04M 3/4936; H04M 2201/39; H04M 2242/12

(57) ABSTRACT

The present invention discloses a novel communication application for facilitating telephonic conversation for deaf or hearing-impaired individuals. The application leverages advanced Text-to-Speech (TTS) and Speech-to-Text (STT) conversion algorithms to allow seamless bidirectional communication across diverse platforms, including landlines. When a hearing-impaired user types text into the application, the innovative TTS technology converts the text into natural-sounding speech that is delivered to the other end of the phone call. Concurrently, speech from the non-hearing-impaired party is captured and transformed into textual content by the advanced STT technology. The text is then displayed in real-time on the user's device screen. The disclosed application ensure that the user can engage in phone conversations just like any other user. Moreover, it prioritizes real-time, accurate conversions, language translation, and maintains the natural flow of a conversation on any telecommunication platform, offering an inclusive solution to the communication challenges faced by the hearing-impaired population.

### CROSS-REFERENCE TO RELATED APPLICATIONS

| | |
|---|---|
| US 20030072420 A1 | 2003 Apr. 17 |
| US 20140355485 A1 | 2014 Dec. 4 |
| U.S. Pat. No. 9,380,150 B1 | 2016 Jun. 28 |
| US 20190347331 A1 | 2019 Nov. 14 |
| US 20170206808 A1 | 2017 Jul. 20 |
| U.S. Pat. No. 11,539,900 B2 | 2022 Dec. 27 |
| US 20230007121 A1 | 2023 Jan. 5 |

This application is a continuation-in-part of U.S. patent application Ser. No. 2003/0072420 filed Apr. 17, 2003.

### BACKGROUND OF THE INVENTION

In the modern world, telephonic communication serves as an essential medium for personal, social, and business interactions. Unfortunately, certain groups of individuals, particularly those with hearing impairments, face significant barriers to full participation in these interactions. For deaf individuals, traditional telephony is not a viable option, and although advancements in technology have led to alternatives such as texting and video calls using sign language, these solutions often lack the immediacy and convenience of a phone call. Furthermore, the language barrier adds another layer of complexity for deaf individuals who need to communicate with people who speak a different language.

Current technology allows voice to be converted into text and vice versa, and automatic language translation has also become relatively common. However, there is no application or device that combines these features in a user-friendly and accessible manner for deaf individuals, enabling them to make and receive phone calls as seamlessly as hearing individuals do, across any telephonic platform, while also overcoming language barriers.

### SUMMARY OF THE INVENTION

The present invention is a unique telecommunication application that bridges this gap and addresses the communication needs of the deaf community. The innovative application is designed to allow a deaf user to communicate with other individuals over a standard phone call using text input which is converted into speech at the receiving end. In the reverse, when the person on the other end of the call speaks, their voice is converted into text which the deaf user can read, effectively creating a real-time “voice” conversation for the user.

Additionally, this application features an integrated real-time language translation feature. This functionality allows both deaf and non-deaf users to communicate seamlessly with individuals who speak a different language. The application translates the input text into the desired language on the other end, and converts spoken language back into the native language of the user in text form.

The present invention can function across various platforms and systems, enabling users to call any telephone, whether a cell phone or a landline. It operates on the premise of a standard phone call, without requiring any specialized equipment or additional applications on the receiver's end. This cross-platform functionality and compatibility with traditional telephony systems set this invention apart and help make communication more inclusive and accessible to everyone, regardless of hearing ability or language spoken.

### BRIEF DESCRIPTION OF DRAWINGS

FIG. 1: This flowchart shows the steps of the algorithm that establishes a connection between the user and the recipient. This is the flow of information, starting with user's text input, translating it to another language if necessary, converting it to audio, sending it to the recipient, returning the voice from recipient, converting it to text, translating it to another language if necessary, and delivering it to the user. The user is using the application, while the recipient is not.

FIG. 2: This is the screen in which the user is live on call with the other line. The user sees it as a text conversation, with the text being inputted being converted to speech using TTS technology, and the messages from the recipient is recipient's voice being live converted to text via STT technology. The user has the options to end the call, mute, unmute, etc. just as a normal phone call. The other line will see the live call as a normal phone call and will not need the application.

FIG. 3: In this screen, the user can scroll their past call history. This is a new innovation within phone calling that comes with this technology. The user will be able to view the text-formatted conversations that they have had with recipients over the phone. It will be recorded and shown in translated text format, allowing for recollection of calls.

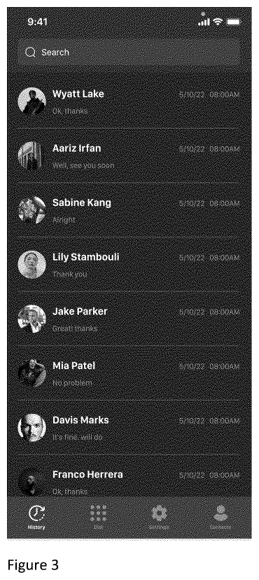

### DETAILED DESCRIPTION OF THE INVENTION

The detailed description of the present invention, herein referred to as the “Deaf Communication Application” (DCA), involves a multi-step process utilizing several APIs (Application Programming Interfaces) and technologies. The primary components include a user interface, a translation service, a Text-to-Speech (TTS) system, a Speech-to-Text (STT) system, an AI, and a telephony API for managing calls. This invention uses Google's TTS and STT APIs, Google Translate API, and Twilio's telephony API.

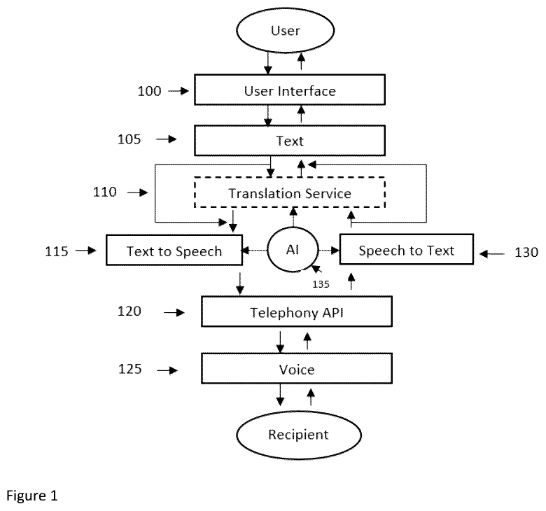

### Text-to-Speech System (FIG. 1—115)

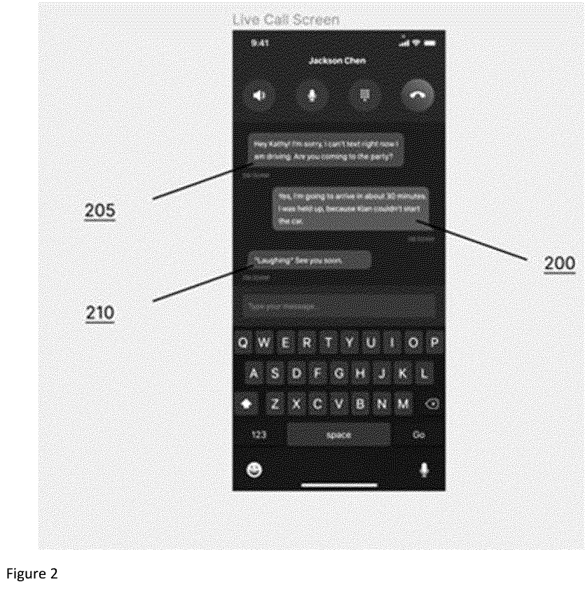

The TTS system is the first step in the process. The deaf user types their message into the application (FIG. 1—105, FIG. 2—200), and the TTS API is called to convert the typed message into speech. For example, using Google's Text-to-Speech API, the message can be synthesized into a human-like voice. Google's TTS service supports multiple languages, which can be selected based on the user's preferences or requirements.

### Telephony API (FIG. 1—120)

Once the message is converted into speech, the telephony API takes over. Using Twilio's programmable voice API, the system initiates a phone call to the designated recipient. The synthesized voice message is sent over the call to the recipient. The Twilio API allows for the connection to any type of phone (mobile, VoIP, or landline), ensuring broad compatibility.

### Speech-to-Text System (FIG. 1—130).

When the recipient responds, their spoken message is captured by the Twilio API and streamed to the application in real-time (FIG. 1—125). This incoming audio stream is processed by Google's Speech-to-Text API to transcribe the spoken words into text (FIG. 1—105, FIG. 2—205). Google's STT API utilizes advanced deep learning neural network algorithms to provide highly accurate transcriptions and also supports multiple languages. For further details of how a TTS can be achieved over phone line connection, see U.S. patent application Ser. No. 2003/0072420, which is incorporated by reference herein,

### Translation Service (FIG. 1—110)

The translated text is then passed to the Google Translate API if the languages of the sender and receiver are different. Google Translate can dynamically detect the language being spoken and translate it into the deaf user's preferred language. This real-time translation service supports numerous languages and allows the DCA to cater to a global user base.

### User Interface (FIG. 1—100)

The resulting text is displayed on the user interface of the DCA for the deaf user to read. The user interface can be designed to be user-friendly and accessible, taking into account the needs of the user. The transcribed and translated message may be displayed in a conversational format similar to text messages or chat applications, ensuring a familiar and intuitive user experience.

### Artificial Intelligence (FIG. 1—135)

Throughout this process, artificial intelligence plays a vital role, particularly in the STT (FIG. 1—130), TTS (FIG. 1—15), and translation services (FIG. 1—110). Machine learning algorithms trained on extensive language datasets ensure the accuracy and efficiency of these services. Continuous learning and improvements are facilitated by incorporating user feedback and new data, further enhancing the performance and user experience over time. This technology will be provided through Google's API.

### Additional Features

Additional features such as conversation history, personalized contact lists, and customizable voice options can be incorporated into the application. The implementation of these features would require additional code and resources but could provide significant benefits in terms of user experience and application functionality.

It should be noted that the current implementation of the invention as described here is one of several possible embodiments. Variations and modifications may be made without departing from the scope and spirit of the invention.

1. An application that connects users to phone calls (landlines included), takes in text input from the user, converting it to speech output using TTS, takes in voice input from the line the user is calling, converting it to speech using artificial intelligence STT.

2. The application according to claim 1, wherein it is cross-platform and functions on iPhones and Androids, able to call any number that operates through landline or cell service.

3. The application according to claim 1, wherein it allows live translation during the call, allowing for calls between users that speak different languages.
